(19) United States
(12) Patent Application Publication
(10) Pub. No.: US 2026/0287018 A1
(43) Pub. Date: Sep. 24, 2026

(54) BEARING ARRANGEMENT, METHOD FOR PRODUCING A BEARING-SEALING ELEMENT, ASSEMBLY METHOD, AND TRANSPORTING METHOD

(71) Applicant: AKTIEBOLAGET SKF, GOTEBORG (SE)

(72) Inventor: Johannes Klaus ZANG, Schweinfurt (DE)

(21) Appl. No.: 19/568,994

(22) Filed: Mar. 17, 2026

(30) Foreign Application Priority Data
Mar. 24, 2025 (DE) 102025111140.5

(51) Int. Cl. F16C 33/78

(52) U.S. Cl. CPC F16C 33/783; F16C 33/7813; F16C 2326/02

(57) ABSTRACT

A bearing arrangement includes a first and a second component each of which is a first bearing ring, a first bearing sub-ring, a first axial element, a first journal, a first shaft, a first washer, a first spacer, a first housing or a first clamping element configured to brace a bearing of the bearing arrangement. At least one sealing-paper element is arranged between the first component and the second component to contribute to a sealing of an interspace between the first component and the second component.

### CROSS-REFERENCE

This application claims priority to German patent application no. 10 2025 111 140.5 filed on Mar. 24, 2025, the contents of which are fully incorporated herein by reference.

### TECHNOLOGICAL FIELD

The disclosure relates to a bearing arrangement, to a method for producing a bearing-sealing element, to an assembly method for assembling a bearing arrangement, and to a method for transporting an incompletely assembled bearing arrangement.

### BACKGROUND

A wheel bearing having a seal which is arranged between an outer ring of the wheel bearing, on the one hand, and two inner rings of the wheel bearing, on the other hand, is known. The seal is annular and seals against the surface whereat the two inner rings contact with each other. In addition, the wheel bearing has a ring which pushes the seal radially inwards against the inner rings. The inner rings are fastened on one another in a form-fitting manner.

### SUMMARY

An aspect of the disclosure is to provide an efficient sealing solution for a bearing arrangement.

The disclosure proceeds from a bearing arrangement having a first component, which is a bearing ring or a bearing sub-ring or an axial element or a journal or a shaft or a washer or a spacer or a housing or a clamping element which is used to brace a bearing of the bearing arrangement, and having at least a second component, which is a bearing ring or a bearing sub-ring or an axial element or a journal or a shaft or a washer or a spacer or a housing or a clamping element which is used to brace a bearing of the bearing arrangement.

The bearing arrangement should have at least one sealing-paper element arranged between the first component and the second component and which at least contributes to sealing of an interspace between the first component and the second component. A "sealing-paper element” should be understood to mean in particular a component which is made at least predominantly or entirely of sealing paper. "Predominantly" should be understood to mean in particular at least 50 percent by mass, preferably at least 75 percent by mass and particularly preferably at least 90 percent by mass. "Sealing paper" should be understood to mean in particular an element consisting of fibers, such as cellulose, aramid or graphite, and at least one binder, such as in particular rubber, resins or plastics, or comprises fibers and at least one binder, wherein a thickness of the element is less than a millimeter and preferably less than 0.6 millimeters, and wherein the element can be in particular rubber-clad. Specifically, it is possible for the fibers here to be compacted and/or based on cellulose. That the sealing-paper element at least "contributes" to sealing of the interspace between the first component and the second component, should be understood to mean in particular that the sealing-paper element together with at least one other component of the bearing arrangement ensures the sealing of the interspace or that the sealing-paper element alone ensures the sealing of the interspace. This can provide an efficient sealing solution for a bearing arrangement. In particular, it is possible to achieve effective and cost-effective sealing of the interspace, easy assembly and easy handling of the bearing arrangement in an incompletely assembled state in which the sealing-paper element has already been fitted.

In particular, the first component and the second component can each be an inner bearing ring or an outer bearing ring.

In particular, if the first component is in the form of an axial element or journal or shaft, the sealing-paper element can butt against an axial stop of the first component. The same can apply to the second component.

The sealing-paper element is advantageously fastened on the first component in a force-fitting and/or form-fitting manner. This allows for easy assembly. In particular, the sealing-paper element can be fastened on the first component in a force-fitting and/or form-fitting manner with respect to an axial direction of the first component that is directed from a center of mass of the first component to a center of mass of the sealing-paper element.

The sealing-paper element advantageously butts against the first component and/or against the second component and/or seals the interspace. This allows for a simple and effective design.

As seen in an axial section through the bearing arrangement, the sealing-paper element should have a first leg and at least a second leg. In this way, various functions of the sealing-paper element can be easily realized. Advantageously, the first component is an inner bearing ring, wherein the first leg is fastened on a radially outer side of the inner bearing ring in a force-fitting and/or form-fitting manner, or an outer bearing ring, wherein the first leg is fastened on a radially inner side of the outer bearing ring in a force-fitting and/or form-fitting manner. As a result, it is possible for the second leg to be available to contribute to the sealing of the interspace or available to seal the interspace.

In addition, the bearing arrangement should include a wheel bearing and the first component should be a first inner bearing ring of the wheel bearing and the second component should be a second inner bearing ring of the wheel bearing and the sealing-paper element should seal the interspace. This allows efficient sealing between the inner bearing rings and a simple design of the seal which seals the interspace.

In particular, the bearing arrangement can be fully assembled.

Also provided is a method which is intended to produce a bearing-sealing element and in which a sealing-paper element is produced. This can provide an efficient sealing solution for a bearing arrangement.

The sealing-paper element is advantageously shaped so as to have an axial direction, wherein the sealing-paper element is formed in such a way that, as seen in an axial section along the axial direction, it has a first leg and at least a second leg and the two legs have different main-extent directions. This makes it possible to create a first region of the sealing-paper element, which is suitable in particular for sealing purposes, and it is possible to create a second region of the sealing-paper element, which is suitable in particular for fastening of the sealing-paper element.

Also provided is an assembly method for assembling a bearing arrangement, in particular a bearing arrangement as described above, wherein a sealing-paper element is fastened on a bearing ring. This can provide an efficient sealing solution for a bearing arrangement. Fastening can advantageously take place in a force-fitting and/or form-fitting manner, easy assembly thereby being achieved.

Additionally provided is a method for transporting an incompletely assembled bearing arrangement, in particular a bearing arrangement as described above, wherein the bearing arrangement is transported while a sealing-paper element of the bearing arrangement is arranged at least in part between a first bearing ring of the bearing arrangement and a second bearing ring of the bearing arrangement and the sealing-paper element is fastened on at least one of the two bearing rings and the two bearing rings have not been braced against one another. This can provide an efficient sealing solution for a bearing arrangement. In particular, it is possible for the sealing-paper element to remain in its desired position even though the bearing arrangement is incompletely assembled.

Advantageously, the sealing-paper element is fastened on the first bearing ring in a force-fitting and/or form-fitting manner, and easy fitting of the sealing-paper element can thereby be achieved.

An further aspect of the disclosure comprises a wheel bearing arrangement including a first inner bearing ring having a radially outer surface and an axially facing end, a second inner bearing ring having a radially outer surface and an axially facing end, and an outer bearing ring surrounding the first inner bearing ring and the second inner bearing ring. A first plurality of rolling elements is located between a first raceway of the outer bearing ring and a raceway of the first inner bearing ring, and a second plurality of rolling elements is located between a second raceway of the outer bearing ring and a raceway of the second inner bearing ring. The axially facing end of the first inner bearing ring and the axially facing end of the second bearing ring face one another across an interspace, and the interspace is sealed by an annular sealing-paper element having a cylindrical first portion mounted on the radially outer surface of the first inner bearing ring and an annular second portion between and in contact with the axially facing end of the first inner bearing ring and the axially facing end of the second bearing ring.

Further advantages emerge from the below description of the drawings. An exemplary embodiment of the disclosure is illustrated in the drawings. The drawings, the description and the claims contain numerous features in combination. A person skilled in the art will expediently also consider the features individually and put them together to form meaningful further combinations. The drawings are provided for purposes of illustrating one or more preferred embodiments of the disclosure only and not for the purpose of limiting same.

### BRIEF DESCRIPTION OF THE DRAWINGS

FIG. 1 is an axial sectional perspective view through a fully assembled bearing arrangement according to the an aspect of the disclosure.

FIG. 2 is an axial sectional perspective view of an enlarged detail of FIG. 1

FIG. 3 is an axial sectional view of the portion of the bearing arrangement illustrated in FIG. 1.

FIG. 4 is an enlarged detail of FIG. 3.

FIG. 5 is a partially exploded perspective view of an embodiment of the disclosure.

### DETAILED DESCRIPTION

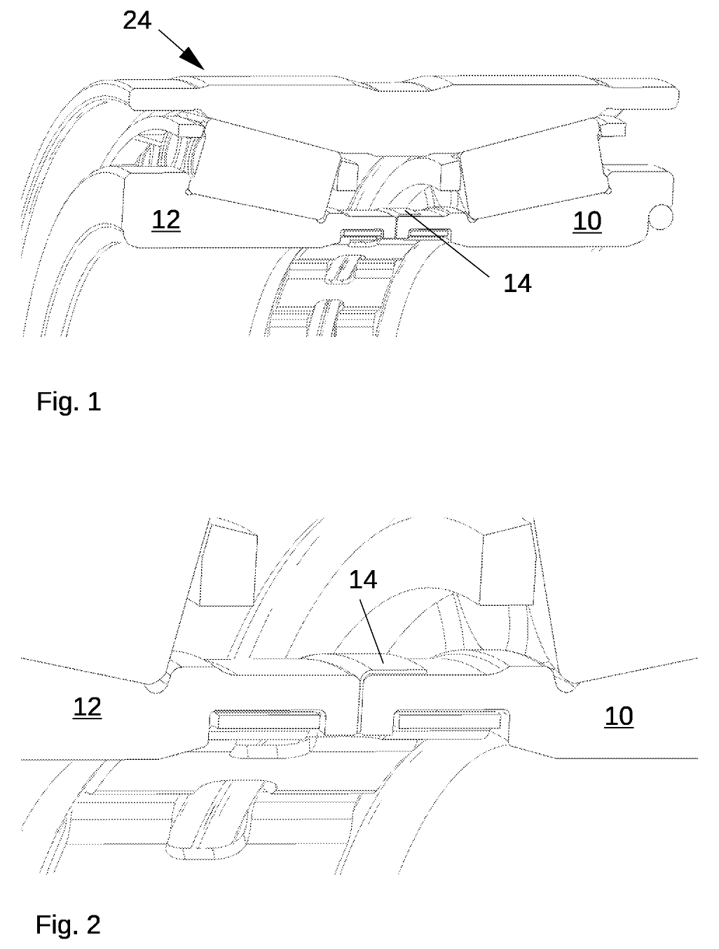

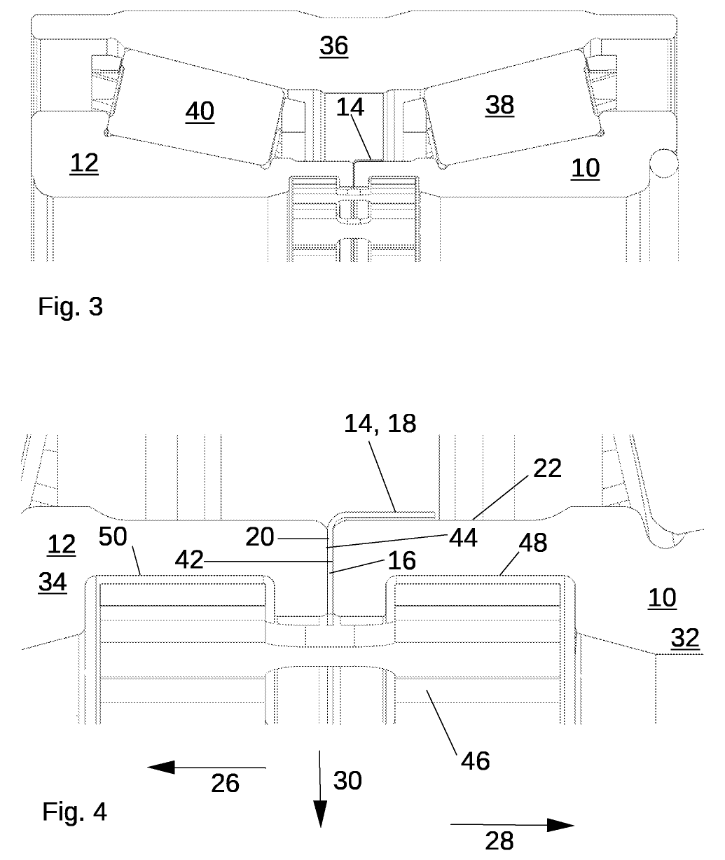

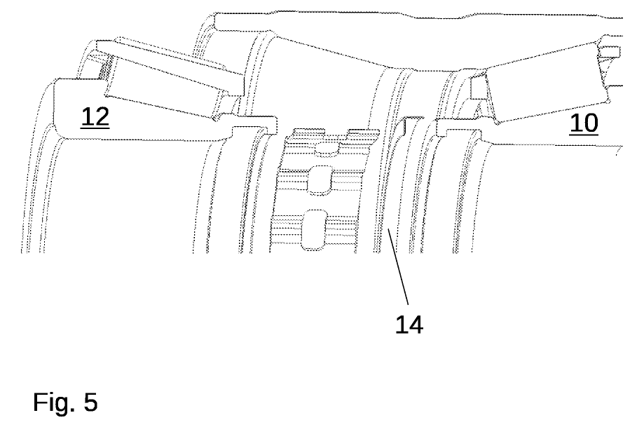

FIG. 1 shows a perspective view through an axial section of a bearing arrangement according to the disclosure, which has a first component 10 and a second component 12. The first component 10 is a bearing inner ring 32 (FIG. 5). The second component 12 is also a bearing inner ring 34 (FIG. 5). Alternatively, the first component 10 and/or the second component 12 can be in the form of a bearing sub-ring or of an axial element or of a journal or of a shaft or of a washer or of a spacer or of a housing or of a clamping element which is used to brace a bearing of the bearing arrangement. The bearing arrangement here is a wheel bearing 24, which has an outer ring 36 and a first row of rolling elements 38 and a second row of rolling elements 40. The rolling elements 38, 40 are tapered rollers, but, in a different exemplary embodiment, may also be of some other design. The rolling elements 38 are arranged between the component 10 and the outer ring 36. Furthermore, the rolling elements 40 are arranged between the component 12 and the outer ring 36.

There is an interspace 16 (FIG. 4) between the first component 10 and the second component 12. More specifically, the interspace 16 is between an end side 42 of the first component 10 and an end side 44 of the second component 12. The two end sides 42, 44 face each other. The bearing arrangement has a sealing-paper element 14, which is arranged between the first component 10 and the second component 12. More specifically, the sealing paper 14 fills the interspace 16 and abuts both the end side 42 and the end side 44 and thereby seals the interspace 16.

The bearing arrangement of FIG. 1 is fully assembled. In this state, a ring 46 ensures that the end side 42 is pushed in an axial direction 26 of the bearing arrangement against the sealing paper 14 and the end side 44 and that the end side 44 is pushed with an equal counterforce against the sealing paper 14 and the end side 42. For this purpose, the ring 46 is fastened on both the component 10 and the component 12 in a form-fitting manner. To realize this form-fitting fastening, the ring 46 engages in a groove 48 of the first component 10 and in a groove 50 of the second component 12. The groove 48 is arranged on a radially inner side of the first component 10 and extends over 360° in the circumferential direction of the first component 10. Furthermore, the groove 50 is arranged on a radially inner side of the second component 12 and extends over 360° in the circumferential direction of the second component 12. The groove 48 is arranged - as seen with respect to the axial direction 26 - between a raceway of the first component 10, this raceway being provided for the rolling elements 38 to roll on, and the end side 42. The groove 50 is arranged - as seen with respect to the axial direction 26 - between a raceway of the second component 12, this raceway being provided for the rolling elements 40 to roll on, and the end side 44.

The sealing-paper element 14 is rotationally symmetrical, but, as an alternative, may also deviate from this shape. An axial direction of the sealing-paper element corresponds to the axial direction 26. As seen in an axial section along the axial direction 26 (FIG. 4), the sealing-paper element 14 here includes a first leg 18 and a second leg 20. The second leg 20 is arranged between the end side 42 and the end side 44 and seals the interspace 16. In the illustration of FIG. 4, the first leg 18 is spaced apart from the component 10.

However, in a second embodiment, which, with the exception of how the first leg 18 is fastened, is formed in the same way as the embodiment which has been described up until now, the first leg 18 butts against the component 10, to be precise on a radially outer side 22 of the component 10, and is fastened on the component 10 in a force-fitting and/or form-fitting manner. The force-fitting fastening is achieved by the first leg 18 exerting a force radially inwards on the outer side 22. The outer side 22 is likewise rotationally symmetrical. The first leg 18 has a main-extent direction 28, which is directed counter to the axial direction 26. Furthermore, the second leg 20 has a main-extent direction 30, which is directed radially inwards and which is thus perpendicular to the main-extent direction 28.

In a method for producing the sealing-paper element 14, fibers of the sealing-paper element 14 are arranged in a shape corresponding to a shape of the desired finished sealing-paper element 14 and are mixed with binder and optionally with at least one further additive. The fibers are kept in this arrangement until the binder hardens. Finally, impregnation or coating with a further material, for example rubber, can optionally also take place.

In a method for assembling the bearing arrangement, the sealing-paper element 14 is fitted onto the first component 10 in a direction counter to the axial direction 26 in such a way that the second leg 20 is in contact with the end side 42 and, in the second embodiment described above, the first leg 18 is in contact with the outer side 22 and the sealing-paper element 14 is thereby fastened on the first component 10 in a force-fitting and/or form-fitting manner, so that for example forces acting on the sealing-paper element 14 in the axial direction 26 do not remove the sealing paper 14 from the first component 10, if these forces are not too great. After the sealing-paper element 14 has been fitted, the first component 10 and the second component 12 are also inserted into the outer ring 36, wherein fitting of the ring 46 is not done in the first instance. The bearing arrangement is then transported in such an incompletely assembled state, wherein the sealing-paper element 14 is arranged between the end side 42 and the end side 44, and the first component 10 and the second component 12 have not been braced against one another because the ring 46 has not yet been installed. Up until the bearing arrangement has been fully assembled, the force-fitting and/or form-fitting fastening of the sealing-paper element 14 on the first component 10 prevents the sealing-paper element 14 from slipping from the first component 10 and getting lost during transportation or insertion of the second component 12 into the outer ring or during final assembly.

The sealing-paper element 14 can also be produced by the already provided sealing paper being moistened and heated, then moved into a position approximately corresponding to a design of the sealing-paper element 14, and subsequently pressed into its final shape.

The relevant wheel of the wheel bearing 24 can be driven. The main-extent directions are perpendicular to one another. The bearing arrangement can be part of a truck (lorry). Alternatively, the sealing-paper element 14 can be fastened on the first component 10 at least with material bonding.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved wheel bearing arrangements.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### LIST OF REFERENCE SIGNS

10 First component

12 Second Component

14 Sealing-paper element

16 Interspace

18 First leg

20 Second leg

22 Outer side

24 Wheel bearing

26 Axial bearing

28 Main-extent direction

30 Main-extent direction

32 Bearing ring

34 Bearing ring

36 Outer ring

38 Rolling element

40 Rolling element

42 End side

44 End side

46 Ring

48 Groove

50 Groove

What is claimed is:

1. A bearing arrangement comprising:
a first component selected from the group consisting of: a first bearing ring, a first bearing sub-ring, a first axial element, a first journal, a first shaft, a first washer, a first spacer, a first housing and a first clamping element configured to brace a bearing of the bearing arrangement, and
a second component selected from the group consisting of a second bearing ring, a second bearing sub-ring, an axial element, a journal, a shaft, a washer, a spacer, a housing and a clamping element configured to brace the bearing of the bearing arrangement, and
at least one sealing-paper element arranged between the first component and the second component to contribute to a sealing of an interspace between the first component and the second component.

2. The bearing arrangement according to claim 1,
wherein the sealing-paper element is connected to the first component in a force-fitting manner and/or form-fitting manner.

3. The earing arrangement according to claim 1,
wherein the sealing-paper element butts against the first component and the second component.

4. The earing arrangement according to claim 1,
wherein the sealing-paper element seals the interspace.

5. The bearing arrangement according to claim 1,
wherein as viewed in an axial section through the bearing arrangement, the sealing-paper element has a first leg and at least a second leg.

6. The bearing arrangement according to claim 5,
wherein the first component is an inner bearing ring and the first leg is fastened on a radially outer side of the inner bearing ring in a force-fitting and/or form-fitting manner, or
wherein the first component is an outer bearing ring and the first leg is fastened on a radially inner side of the outer bearing ring in a force-fitting and/or form-fitting manner.

7. The bearing arrangement according claim 1,
including a wheel bearing,
wherein the first component is a first inner bearing ring of the wheel bearing and the second component is a second inner bearing ring of the wheel bearing and the sealing-paper element seals the interspace.

8. The bearing arrangement according to claim 1,
wherein the first component is the first bearing ring and the second component is the second bearing ring.

9. A method for transporting an incompletely assembled bearing arrangement, comprising:
providing a first bearing ring,
fastening a sealing-paper element on the first ring, and
placing a second bearing ring against the sealing-paper element.

10. A wheel bearing arrangement comprising:
a first inner bearing ring having a radially outer surface and an axially facing end,
a second inner bearing ring having a radially outer surface and an axially facing end,
an outer bearing ring surrounding the first inner bearing ring and the second inner bearing ring, and
a first plurality of rolling elements between a first raceway of the outer bearing ring and a raceway of the first inner bearing ring and a second plurality of rolling elements between a second raceway of the outer bearing ring and a raceway of the second inner bearing ring,
wherein the axially facing end of the first inner bearing ring and the axially facing end of the second bearing ring face one another across an interspace, and
wherein the interspace is sealed by an annular sealing-paper element having a cylindrical first portion mounted on the radially outer surface of the first inner bearing ring and an annular second portion between and in contact with the axially facing end of the first inner bearing ring and the axially facing end of the second bearing ring.
